(19) United States
(12) Patent Application Publication
(10) Pub. No.: US 2017/0061167 A1
(43) Pub. Date: Mar. 2, 2017

(54) SKIMMER DEVICE DETECTION

(71) Applicant: NCR Corporation, Duluth, GA (US)

(72) Inventor: Grant McNicoll, Angus (GB)

(21) Appl. No.: 14/835,139

(22) Filed: Aug. 25, 2015

(51) Int. Cl. G06K 7/00; G06K 13/08; G06K 13/07; G06K 7/08

(52) U.S. Cl. CPC G06K 7/0095; G06K 7/084; G06K 13/0875; G06K 13/07

(57) ABSTRACT

Various embodiments herein each include at least one of systems, devices, methods, data structures, and software for skimmer device detection within self-service terminals, and more particular with regard to card reading devices. One such embodiment is a method that includes monitoring a card position within a card reader device based on signals received from a plurality of card position sensors of the card reader device in view of an expected card travel pattern data structure to identify card reader tampering. This method further includes declaring a card reader device tampering event when at least one signal received from at least one of the card position sensors does not match data of the expected card travel pattern data structure. The method then executes at least one card reader device tampering event process upon a declared card reader tampering event.

### BACKGROUND INFORMATION

Card reader devices are typically used in transaction terminals to enable customer identification. One type of card reader device is a motorized card reader/writer (MCRW) device. A common type of transaction terminal is a Self-Service Terminal (SST), such as an automated teller machine (ATM).

Bank customers can use an ATM to access funds from their accounts using an ATM card that typically has an associated personal identification number (PIN). Any user who presents a valid ATM card and enters the correct PIN associated with that card has immediate access to funds in an account controlled by that ATM card. This makes ATM cards vulnerable to theft and to more surreptitious attacks, such as duplication of the card by illicitly reading magnetic information stored on the card, commonly referred to as card “skimming”. As many modern ATM cards may also be used as debit cards or to access lines of credit associated with the cards at retail outlets similar to credit cards and without a PIN, compromised cards can lead to substantial fraud. Skimming can occur by fraudulent actors placing skimming devices within a card reader device, such as an MCRW, that reads and stores ATM and credit card numbers for later retrieval and exploitation. Skimming devices are difficult to detect and are typically not readily visible.

In the past, skimming has occurred by fraudulent actors placing a skimming device on the outside of a card reader device to read a magnetic stripe track on a card as it is being inserted. Recently, a new type of skimming device has been detected, where the skimming device is inserted into the card reader device itself.

### SUMMARY

Various embodiments herein each include at least one of systems, devices, methods, data structures, and software for skimmer device detection within self-service terminals, and more particular with regard to card reading devices. One such embodiment is a method that includes monitoring a card position within a card reader device based on signals received from a plurality of card position sensors of the card reader device in view of an expected card travel pattern data structure to identify card reader tampering. This method further includes declaring a card reader device tampering event when at least one signal received from at least one of the card position sensors does not match data of the expected card travel pattern data structure. The method then executes at least one card reader device tampering event process upon a declared card reader tampering event.

Another method embodiment includes receiving a card by a card reader device of an SST to initiate an SST transaction. This method then monitors a position of the card within the card reader device based on signals received from a card width sensor, a shutter detect sensor, and a plurality of card position sensors of the card reader device in view of an expected card travel pattern data structure to identify card reader tampering. When at least one signal received from at least one of the card width sensor, shutter detect sensor, and card position sensors does not match data of the expected card travel pattern data structure, the method declares a card reader device tampering event. The method then executes at least one card reader device tampering event process upon the declared card reader tampering event. The card reader device tampering event process may include transmitting a tampering event signal to a controlling computer of the SST to immediately take the SST offline. However, when no card reader device tampering events have been declared during a transaction, the method outputs the card from the card reader device upon completion of the SST transaction.

Further embodiments take the form of a card reader device. Card reader devices of such embodiments include a card entrance for receiving a card including a first read head for detecting data stored by the card and a card enclosure in registration with the card entrance and defining an area in which the card is read including a second read head. These embodiments further include a shutter for controlling access to the card enclosure from the card entrance and a linear transport mechanism that transports a card received along a linear transport path via the card entrance when the shutter is open. Various sensors are present in such card readers, such as a card width sensor, a shutter detect sensor that detects open and closed positions of the shutter, and a plurality of card position sensors along linear transport path positions to detect the presence of a card at the respective position. Card readers of such embodiments further include a controller having a processor and a memory that is operable to control the card reader device by executing data processing activities. The data processing activities may include monitoring a position of a card at the card entrance and along the linear transport path based on signals received from the card width sensor, the shutter detect sensor, and the plurality of card position sensors in view of an expected card travel pattern data structure stored in the memory to identify card reader device tampering. The data processing activities may also include declaring a card reader device tampering event when at least one signal received from at least one of the card width sensor, shutter detect sensor, and card position sensors does not match data of the expected card travel pattern data structure. When no card reader device tampering event has been declared the data processing activities include outputting the card from the card reader device. However, upon a declared card reader device tampering event, the data processing activities include executing at least one card reader device tampering event process. The at least one card reader device tampering process may include transmitting a tampering event signal to a computer coupled to the card reader device to immediately take the computer offline.

Another embodiment enables a card reader to detect a skimmer while the skimmer is being inserted into the card reader by monitoring signals associated with sensors in the card reader.

### BRIEF DESCRIPTION OF THE DRAWINGS

FIG. 1 is a front view of a motorized card reader device according to an example embodiment.

FIG. 2 is a simplified side view of the device of the motorized card reader device of FIG. 1.

FIG. 3 is a rear view of a conventional magnetic stripe card for use with the motorized card reader device of FIGS. 1 and 2.

FIG. 4 is a schematic diagram showing a disabling device of the motorized card reader device of FIG. 2 in greater detail.

FIG. 5 is a flowchart illustrating a method of operation of the motorized card reader device of FIGS. 1 and 2.

FIG. 6 is a block flow diagram of a method, according to an example embodiment.

FIG. 7 is a block flow diagram of a method, according to an example embodiment.

### DETAILED DESCRIPTION

Various embodiments herein each include at least one of systems, devices, methods, data structures, and software for skimmer device detection within self-service terminals, and more particular with regard to internal skimming devices that are inserted into card reading devices. Skimming devices are typically quite small and well-tailored to fit within a card path of a card reading device. Detection of card skimmers is therefore difficult. However, various embodiments herein provide solutions to identify when a skimming device may have been introduced into a card path of a card reader. Some such embodiments leverage various sensors present in card reader devices, such as a card width detector, a shutter position sensor, and card position sensors. Data of these sensors is compared by a controller of the card reader to expected position sensor output. When anomalies are detected in the comparing, a card reader tampering event may be declared. For example, if a card is expected to be within a MCRW at a card read position with the shutter closed and the card is sensed to be in the proper position, but the shutter sensor indicates the shutter is open and another sensor that should not be detecting the card indicates the card is also present in that location, this indicates that something unexpected is or has been introduced into the card path. The controller may then declare the card reader tampering event and take appropriate action, such as by sending a signal to a computer that controls an SST within which the card reader is deployed to cease the current transaction and send a notification to appropriate personal or systems via a network.

These and other embodiments are described herein with regard to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, Application Integrated Circuit (ASIC), microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

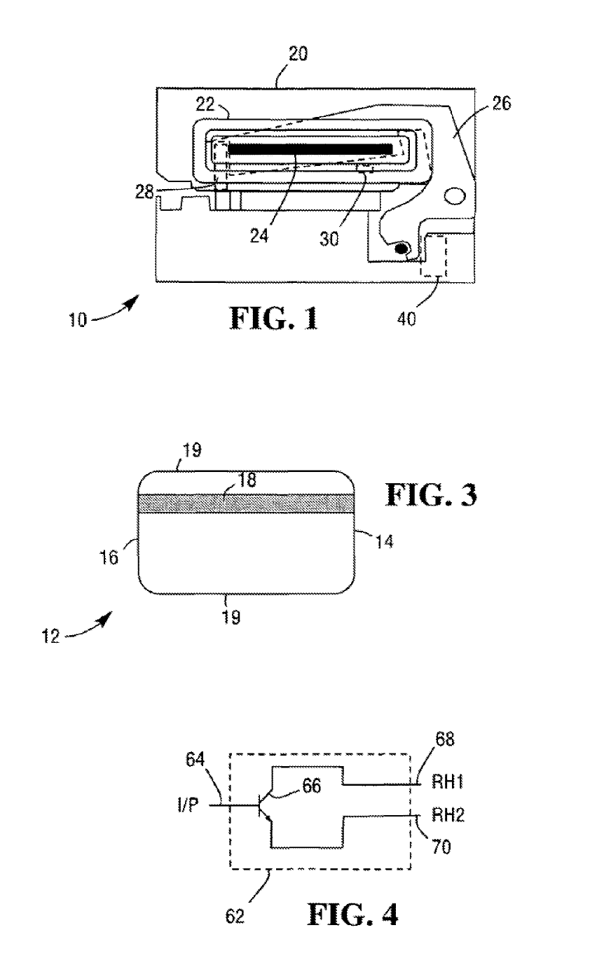

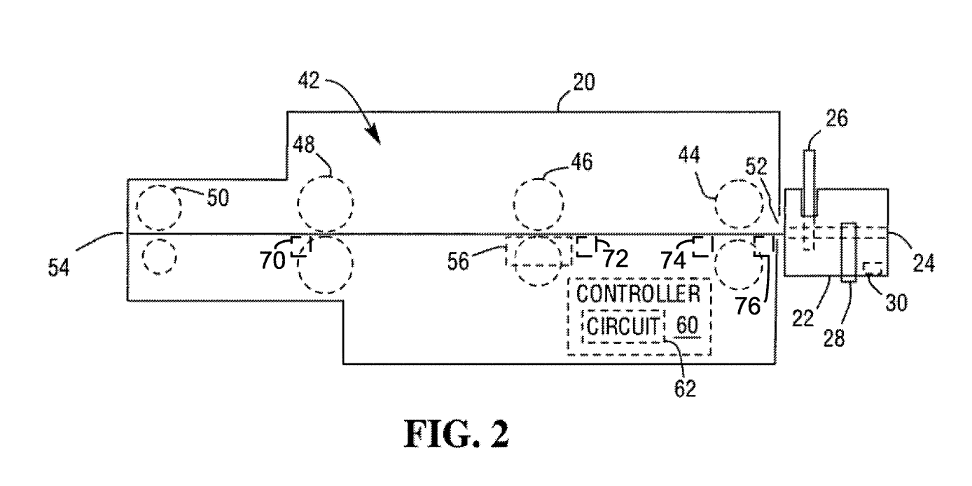

FIG. 1, is a front view of a motorized card reader device 10, hereinafter “card reader 10”, according to one embodiment, and also to FIG. 2, which is a side view of the card reader 10. Reference is also made to FIG. 3, which is a rear view of a conventional magnetic stripe ATM card 12 for use with the card reader 10. An ATM card 12 may be a card associated with one or more savings, credit, money market, line of credit, credit card, medical savings, food stamp, welfare, and other accounts to access money or credit of the respective account.

The card reader device 10 of FIG. 1 and FIG. 2 is an example card reader device that may be utilized in some embodiments. However, there are different motorized card reader devices that include variances from the illustrated card reader device 10, such as in the number of rollers and sensors that are present, presence, or lack thereof, of a card chip reader, and other variances. Thus, the illustrated card reader device 10 is not intended to be limiting, but rather is provided as an example.

The ATM card 12 comprises a leading (narrow) edge 14 opposite a trailing (narrow) edge 16, and a magnetic stripe 18 extending from the leading edge 14 to the trailing edge 16 parallel to long edges 19.

The card reader 10 comprises a housing 20 coupled to a card entrance in the form of a throat portion 22. The throat portion 22 defines a slot 24 dimensioned for receiving the ATM card 12 leading edge 14 first. The throat portion 22 also includes a shutter 26 pivotally coupled to the housing 20 for controlling access from the throat portion 22 to the housing 20.

When the shutter 26 is in the open position, a card, such as ATM card 12, may be transported from the throat portion 22 to the housing 20; whereas, with the shutter 26 in the closed position no card may pass between the throat portion 22 and the housing 20.

Once the leading edge 14 of the ATM card 12 passes the shutter 26, the shutter 26 is released and biased against the top of the ATM card 12 so that the shutter 26 automatically closes once the trailing edge 16 of the ATM card 12 clears the shutter 26.

The throat portion 22 includes two sensors for verifying that an object inserted by the customer is actually a bank or credit card. The shutter 26 is only opened if the correct signals are received from both sensors.

The first sensor 28 is a card width detection sensor 28. This sensor 28 is deflected by the ATM card 12 on insertion and ejection of the card. If a customer inserts a card into the throat portion 22 then the card width sensor 28 detects the presence of this card.

The second sensor 30 is a pre-shutter read head, in the form of a magnetic flux detector. This second sensor 30 is located at a point in the throat portion 22 over which the magnetic stripe 18 of the ATM card 12 should pass. The first sensor 28 verifies that the ATM card 12 has the correct width, the second sensor 30 verifies that the ATM card 12 is correctly oriented. If both first and second sensors 28, 30 respond correctly to an inserted object, such as an ATM card 12, then the shutter 26 is opened, as will be described in greater below.

The housing 20 also includes a shutter detect sensor 40 for detecting whether the shutter 26 is open or closed.

Referring specifically to FIG. 2, the housing 20 includes a linear transport mechanism 42 comprising four pairs of rollers 44, 46, 48, 50 and associated stretchable endless belts (not shown) for transporting the ATM card 12 when it is at least partially within the housing 20. While the linear transport mechanism 42 illustrated include four pairs of rollers 44, 46, 48, 50, other linear transport mechanisms may include fewer roller pairs or more roller pairs. The housing 20 defines an entrance/exit slot 52 at one end and a card retention slot 54 at the opposite end. The housing 20 also includes a card read/write head 56 for reading data from the ATM card 12 and writing data to the ATM card 12 as necessary. The housing 20 also includes multiple position sensors 70, 72, 74, 76 for accurately locating the position of the ATM card 12 within the housing 20. A controller 60 is also provided within, or coupled to, the housing 20 to control operation of the other components of the card reader 10, such as the shutter 26, the first and second sensors 28, 30, the linear transport mechanism 42, the read/write head 56, and the like.

The controller 60, in some embodiments, includes a disabling device circuit 62 for disabling the pre-shutter read head of the second sensor 30, as shown in FIG. 4. In this embodiment, the disabling device circuit 62 is in the form of a simple transistor switching circuit. The circuit 62 has a switching input 64 from the controller 60, a transistor 66, and two outputs 68, 70 coupled to two output lines (not shown) from the pre-shutter read head, second sensor 30. When the switching input 64 is activated by the controller 60, the transistor 66 is activated, allowing current to flow between the two output lines of the pre-shutter read head, second sensor 30. This short-circuits the pre-shutter read head, second sensor 30, thereby preventing the pre-shutter read head, second sensor 30, from reading a magnetic stripe. The circuit 62, however, is not present in all embodiments.

The controller 60 also typically includes a processor and a memory device, although in some embodiments the processor and the memory device may be an ASIC firmware device with an updateable flash memory. The memory stores instructions and data to control operation of the card reader 10. The card memory, in some embodiments, stores at least one expected card travel pattern data structure. An expected card travel pattern data structure includes data representative of combinations of sensor signals expected at times during a period while the ATM card 12 is present within the card reader 10 and manipulated to different positions along a linear transport path of the linear transport mechanism 42 under direction of the controller 60. In some embodiments, the expected card travel pattern data structure instructs the controller 60 of how to move the ATM card 12. As the linear transport mechanism 42 moves the ATM card 12 along the linear transport path in a pattern defined by the expected card travel pattern data structure under direction by the controller 60, the controller 60 monitors movement of the ATM card 12. The ATM card 12 movement is monitored through sensor signals received by the controller 60, such as from 76, 74, 72, 70, shutter detect sensor 40, and width sensor 28. The controller 60 monitors the sensor signals to verify the ATM card 12 is in an expected position and that nothing else, such as a card skimming device has been introduced into the housing 20. Such a card skimming device is a device used to perpetrate ATM card 12 fraud by fraudulently reading and storing ATM card 12 data read from the magnetic stripe 18 for later retrieval and fraudulent use.

In some embodiments, the memory of the controller 60 stores a plurality of expected ATM card 12 travel pattern data structures. Thus, when the card reader 10 receives an ATM card 12, the controller 60 selects an expected card travel pattern data structure from the plurality of expected card travel pattern data structures. The controller 60, depending on the particular embodiment, may select the expected card travel pattern data structure in various ways. In one embodiment, an expected card travel pattern data structure is selected from ten that are each uniquely numbered between zero (0) and nine (9). The selection may be random such as according to a random number generation or selection process that outputs a number between zero (0) and nine (9) that identifies the expected card travel pattern data structure to select.

The controller 60 also includes a device interconnect to couple the card reader 10 to a computer, such as a computer that controls operation of an SST, such as an ATM. The device interconnect may be a Universal Serial Bus (USB) connector or other connector type.

With regard to the position sensors 76, 74, 72, 70 the housing 20 in some embodiments includes four position sensors for accurately locating a position of the ATM card 12 within the housing 20. However, other embodiments may include a smaller or larger number of position sensors placed at the same or different locations within the housing 20, such as a position sensor that may be located in the vicinity of or with the card read/write head 56. The position sensors 76, 74, 72, 70 may each individual be optical, capacitive, resistance, pressure, and other types of sensors, although a commonly used sensor type is an infrared optical sensor. Regardless of the type of sensor, the position sensors 76, 74, 72, 70 identify when the ATM card 12 is present at a location of the respective sensor and provides signals to the controller 60 indicative thereof.

In some such embodiments, a position sensor 76 is located in the vicinity of the throat portion 22 at the first pair of rollers 44. Another position sensor 74 is located a predetermined distance from the throat portion 22 while a third position sensor 72 is located at the second pair of rollers 46 in the vicinity of the card read/write head 56. A fourth position sensor 70 is located distal from the throat portion 22 at the third pair of rollers 48.

The four position sensors 76, 74, 72, 70 are located so that once a card enters the housing 20, it can always be located by at least one of the position sensors 76, 74, 72, 70, unless the card is conveyed elsewhere within the housing 20. The ATM card 12 may be conveyed elsewhere in the event a card is to be retained, such as if a presented ATM card 12 is determined to have been reported stolen or lost or is not taken from the card reader 10 within a timeout period.

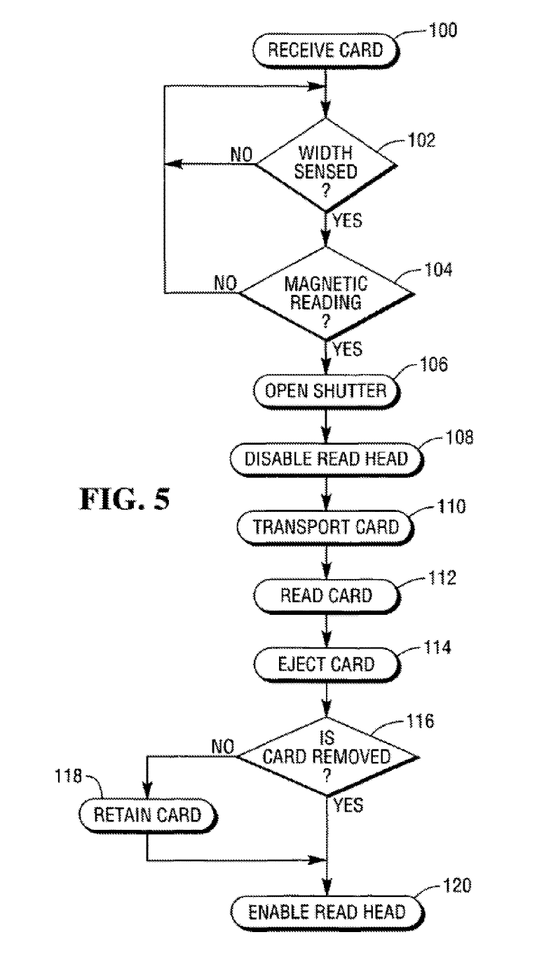

The operation of the card reader 10, according to some embodiments, is now described with reference to FIG. 5. FIG. 5 is a flowchart illustrating a method of reading an ATM card 12 in some embodiments. In some embodiments, the method of FIG. 5 is performed in whole or in part by the controller 60. When the controller 60 does not perform the entirety of the method, other portions may be performed by another ATM device, such as a controller that controls operation of the ATM. Thus, the controller 60 is typically coupled to a computer that controls operation of the ATM. The controller may receive signals and commands therefrom and provide outputs, commands, and other signals thereto. Such outputs, commands, and signals may include data read from an ATM card 12, data and commands with regard to card reader 10 errors, possible fraud detections by the controller 60, and the like.

Initially, the example method of FIG. 5 includes a customer inserting an ATM card 12 into the throat portion 22 slot 24 of card reader 10, so that the card reader 10 receives the ATM card 12 (step 100).

The controller 60 continually monitors the card width sensor 28 (step 102). If the card width sensor 28 is not deflected then the controller 60 takes no action. Insertion of the ATM card 12 deflects the card width sensor 28, which sends an output to the controller 60 indicating that the inserted object (the ATM card 12 in this example) has the correct width.

The controller 60 then ascertains if the pre-shutter read head, second sensor 30, detects any magnetic flux (step 104). The pre-shutter read head, second sensor 30, will detect magnetic flux on the ATM card 12 if the ATM card 12 is oriented correctly when it is inserted. If no magnetic flux is detected then the controller 60 takes no action. If magnetic flux is detected and the card width sensor 28 remains deflected then the controller 60 opens the shutter 26 (step 106).

The controller 60 may then disable the pre-shutter read head, second sensor 30, by activating the switching input 64 (step 108). This causes the transistor 66 to switch-on and short-circuit the pre-shutter read head, second sensor 30. However, as not all embodiments include the circuit 62 of FIG. 2 and FIG. 4, not all embodiments of the method illustrated in FIG. 5 include the step 108.

Once the pre-shutter read head, second sensor 30, has been deactivated, the controller 60 transports the ATM card 12 within the housing 20 (step 110) and allows the shutter 26 to urge against the top of the ATM card 12 so that when the ATM card 12 clears the shutter 26, the shutter 26 will automatically close. The shutter detect sensor 40 detects when the shutter 26 has closed and continually monitors the shutter 26 to inform the controller 60 of the shutter 26 position.

Once the ATM card 12 is fully enclosed by the housing 20, and the shutter 26 is fully closed, the controller 60 reads the ATM card 12 for use in a transaction (step 112).

If a fraudster tries to intercept the signal from the pre-shutter read head, second sensor 30, then no signal will be detected because the two output lines (not shown) from the pre-shutter read head, second sensor 30, have been short-circuited.

The controller 60 then ejects the ATM card 12 (step 114) using the linear transport mechanism 42 to present the ATM card 12 to the customer.

The controller 60 ascertains if the ATM card 12 is removed by the customer (step 116), for example, by detecting closure of the shutter 26 using the shutter detect sensor 40.

If the customer does not take the ATM card 12 within a pre-determined time period (for example, fifteen seconds) then the card reader 10 transports the ATM card 12 to the card retention slot 54 for secure storage of the ATM card 12 (step 118).

If the customer does take the ATM card 12, some embodiments including the circuit 62 include the controller 60 enabling the pre-shutter read head, second sensor 30, by de-activating the switching input 64 (step 120). This causes the transistor 66 to switch off, thereby open circuiting the pre-shutter read head, second sensor 30. This leaves the pre-shutter read head, second sensor 30, ready to detect magnetic flux on the next ATM card to be presented by a customer.

The card reader 10 can easily be incorporated into a self-service terminal, such as an automated teller machine (ATM), a non-cash kiosk, a self-checkout terminal, a check-in/check-out terminal, or the like.

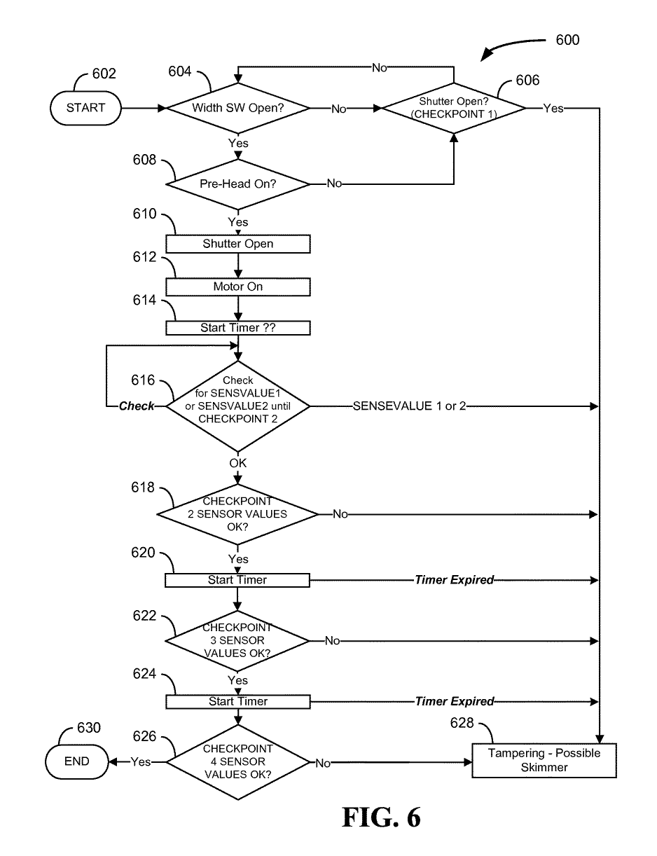

FIG. 6 is a block flow diagram of a method 600, according to an example embodiment. The method 700 is an example of a method that may be performed by a card reader device, such as the card reader device 10 of FIG. 1 and FIG. 2.

FIG. 6 is a block flow diagram of a method 600, according to an example embodiment. The method 600 is an example of a method that may be performed by a card reader device, such as the card reader device 10 of FIG. 1 and FIG. 2. The method 600 will be described with reference to the card reader device 10 illustrated and described above with regard to FIG. 1 and FIG. 2.

The example method 600 begins at start block 602 when an ATM card, such as ATM card 12 of FIG. 3, is presented at the throat portion 22 of the card reader device 10. At block 604, the method 600 determines whether a signal from the first sensor 28, the card width sensor, is correct for an ATM card. If not, the method 600 proceeds to block 606 where a shutter detect sensor 40 output is consulted to determine whether the shutter is open. If not, the method 600 returns to block 604. If the shutter is open and the card width is not correct, the method proceeds to block 628 where a card reader device 10 tampering event is declared indicating a possible attempt to insert a skimming device into the card reader 10 or that a skimming device has already been inserted.

Returning to block 604, when the first sensor 28 indicates the card width is proper, the method 600 proceed to block 608 and check the second sensor 30, the pre-shutter read head, value to determine if a magnetic stripe 18 is present on the ATM card 12. If not, the method 700 proceeds to block 606 as discussed above. However, when a magnetic stripe is present on the ATM Card, the method 700 proceeds from block 608 to blocks 610, 612, and 614. At these blocks 610, 612, and 614, the method 600 opens the shutter 26, turns on a motor of the linear transport mechanism 42, and may start a timer. The timer may be used by the controller 60 to track elapsed time either for a certain event or value received from a sensor, such as may be defined within an expected card travel pattern data structure. Alternatively, the timer may be used to track with regard to fixed time points defined within the expected card travel pattern data structure that instructs the controller 60 of how and when to manipulate the linear transport mechanism 42 to move the ATM card 12 to positions along the linear transport path. An example of an expected card travel pattern data structure is illustrated in TABLE 1 below.

TABLE 1 is an example of data stored within an expected card travel pattern data structure. The data includes a time column and sensor columns with regard to the various sensors within the card reader device 10. As illustrated, each sensor column is labeled in the expected card travel pattern data structure of TABLE 1 with a reference number of the sensor for which the following data in the column applies. A value of 0 with regard to the position sensors 70, 72, 74, 76 indicates the ATM card 12 is not sensed as present and a value of 1 indicates a sensed presence. There are also columns for the shutter detect sensor 40 and the width sensor 28. Note however that a sensed presence is the presence of something and not necessarily the ATM card 12. The values in the shutter detect sensor 40 column are 1 for open and 0 for closed. The values in the width sensor 28 columns are 1 for a sensed proper width and 0 for either sensing nothing or something with an improper width. As a point of reference, the proper width of the ATM card 12 is approximately 53 millimeters.

As can be seen in TABLE 1, at time 1, the ATM card is presented at the width sensor 28, the shutter then opens at time 2 as in the method 600 at block 610, and then the card begins its path into the card reader and then back out at time 24. The data of the expected card travel pattern data structure illustrated in TABLE 1 is read by the controller 60 and the controller sends commands to the linear transport mechanism is accordance therewith. The controller 60 then monitors sensor values at the times 1-24 to validate that the sensors are providing compliant values. When the values are compliant, all is well. However, when the sensor values are not compliant, a foreign item involved with a skimming device may be present an appropriate action is taken to prevent fraud.

TABLE 1
ATM card 12 position sensed along linear transport mechanism 42 during a
transaction.

| | POSITION | POSITION | POSITION | POSITION | SHTR DETECT | WIDTH |
|---|---|---|---|---|---|---|
| TIME | SENSOR 70 | SENSOR 72 | SENSOR 74 | SENSOR 76 | SENSOR 40 | SENSOR 28 |
| 1 | 0 | 0 | 0 | 0 | 0 | 1 |
| 2 | 0 | 0 | 0 | 0 | 1 | 1 |
| 3 | 0 | 0 | 0 | 1 | 1 | 1 |
| 4 | 0 | 0 | 1 | 1 | 1 | 1 |
| 5 | 0 | 1 | 1 | 1 | 1 | 0 |
| 6 | 0 | 1 | 1 | 1 | 0 | 0 |
| 7 | 1 | 1 | 1 | 0 | 0 | 0 |
| 8 | 1 | 1 | 0 | 0 | 0 | 0 |
| 9 | 1 | 0 | 0 | 0 | 0 | 0 |
| 10 | 1 | 0 | 0 | 0 | 0 | 0 |
| 11 | 1 | 1 | 0 | 0 | 0 | 0 |
| 12 | 1 | 1 | 1 | 0 | 0 | 0 |
| 13 | 0 | 1 | 1 | 1 | 0 | 0 |
| 14 | 0 | 1 | 1 | 1 | 0 | 0 |
| 15 | 0 | 0 | 1 | 1 | 0 | 0 |
| 16 | 0 | 0 | 1 | 1 | 0 | 0 |
| 17 | 0 | 0 | 1 | 1 | 0 | 0 |
| 18 | 0 | 0 | 1 | 1 | 0 | 0 |
| 19 | 0 | 0 | 1 | 1 | 0 | 0 |
| 20 | 0 | 0 | 1 | 1 | 0 | 0 |
| 21 | 0 | 0 | 1 | 1 | 1 | 1 |
| 22 | 0 | 0 | 0 | 1 | 1 | 1 |
| 23 | 0 | 0 | 0 | 0 | 1 | 1 |
| 24 | 0 | 0 | 0 | 0 | 0 | 0 |

The expected card travel pattern data structure illustrated in TABLE 1 is an example of an expected card travel pattern data structure tailored to the number of sensors present in a card reader device. The number of columns in other expected card travel pattern data structures may therefore vary depending on the number of sensors present within a card reader device of a particular embodiment. Further, some embodiments may not consider data from all sensors of a card reader device. Thus, the number of columns may be equal or less than the number of sensors present in a card reader device of a particular embodiment.

The expected card travel pattern data structures define patterns of card movement by the linear transport mechanisms 42 that are generally at least difficult for a fraudster to replicate while attempting to insert a skimming device. Further, some expected card travel pattern data structures may place the ATM card 112 in a position close to the throat portion 22, yet still within the housing 20, that essentially blocks, or makes access more difficult, for anyone attempting to insert a skimming device. Note as well that the data of expected card travel pattern data structures may be coded within card reader device software or stored as a configuration setting. Thus, the expected card pattern data structures need not be a distinct data structure in all embodiments.

Returning to the method 600 proceeds from block 614 to block 616 and the controller 60 checks for certain sensor values, such as the presence of the ATM card 12 being detected by position sensor 76 or 74. If the proper sensor value is not received within an appropriate time or at a specific time, depending on the expected card travel pattern data structure of the particular embodiment, the block 616 times out and method proceeds to block 628. The same type of processing occurs at each of blocks 618, 622, and 626. However, at various points, timeout timers, such as at blocks 620 and 624 may also be triggered that add time out periods within which certain actions should occur, such as the ATM card being read by the card read/write head 56 or the ATM card 12 should be sensed in by a certain presence sensor. When block 626 completes and the sensor values are appropriate, the method 600 proceeds to block 630 and ends.

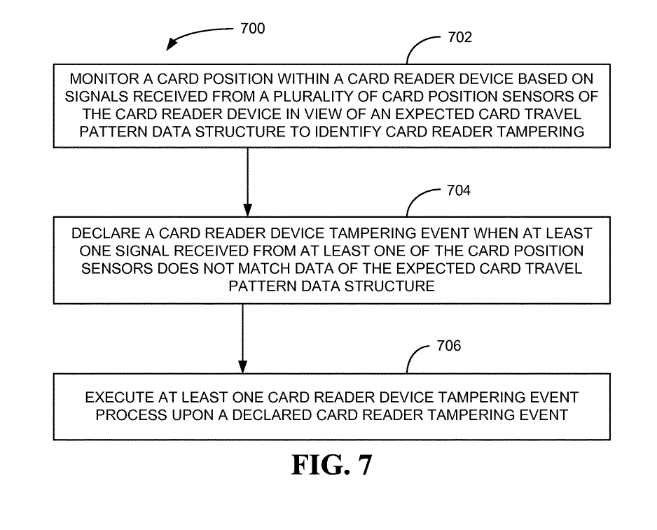

FIG. 7 is a block flow diagram of a method 700, according to an example embodiment. The method 700 is another example of a method that may be performed by a card reader device, such as the card reader device 10 of FIG. 1 and FIG. 2.

The example method 700 includes monitoring 702 a card position within a card reader device based on signals received from a plurality of card position sensors of the card reader device in view of an expected card travel pattern data structure to identify card reader tampering. When at least one signal received from at least one of the card position sensors does not match data of the expected card travel pattern data structure, the method 700 declares 704 a card reader device tampering event and executes 706 at least one card reader device tampering event process upon a declared card reader tampering event.

In some embodiments of the monitoring 702 the card position within the card reader device is further performed based on signals received from a card width sensor and a shutter detect sensor.

In some embodiments, declaring the at least one card reader tampering device includes a controller of the card reader device disabling the card reader device. Disabling the card reader device may include activating the circuit 62 of FIG. 2 and FIG. 4 as described above when such a circuit 62 is present in the particular embodiment.

In some embodiments, the at least one card reader device tampering event may include the controller of the card reader device transmitting a signal to an SST controlling process that controls operation of an SST within which the card reader device is present. This signal is an instruction to cancel a current transaction when a transaction is in progress and taking the SST offline. The signal transmitted by the controller of the card reader device to the SST controlling process may further cause the SST controlling process to transmit an alert over a network to an SST management system.

The expected card travel pattern data structure in some embodiments of the method 700 includes data representative of combinations of sensor signals expected at times during a period while the card is present within the card reader device. In some further embodiments of the method 700, the expected card travel pattern data structure instructs the controller of the card reader device of a pattern for transporting the card within the card reader device through manipulation of a linear transport mechanism. The patterns may include back and forth movements on the linear transport path. In some such embodiments, the expected card travel pattern data structure is one of a plurality of expected card travel pattern data structures stored within a memory of the card reader device controller. The expected card travel pattern data structure utilized may then be selected from the plurality of expected card travel pattern data structures, such as according to a defined schedule, a randomization algorithm, and among other selection techniques.

Another method embodiment includes monitoring signals from a plurality of sensors located within a card reader and comparing the monitored sensor signals with an expected pattern of signals. An alert is then declared in such embodiments when the monitored sensor signals do not match the expected pattern of signals. In some such embodiments, the monitored signals may include a shutter open sensor signal and the expected pattern of signals does not include the shutter open sensor signal indicating that a shutter is open when a card is not detected in any part of the card reader. This would lead to the declaring of the alert. In another instance of some such embodiments, one of the monitored sensor signals includes a shutter open sensor and the expected pattern of signals does not include the shutter open sensor indicating that a shutter is open when a card is located within the card reader at a point at which the shutter should be closed. This too, would lead to the declaring of the alert.

A further method of operating a card reader device according to some embodiments includes transporting a card within a card reader according to a card travel pattern and monitoring signals from a plurality of sensors located within the card reader. This method further includes comparing the monitored sensor signals with an expected pattern of signals corresponding to the card travel pattern. An alert may then be declared when the monitored card position sensor signals do not match the expected pattern of signals corresponding to the card travel pattern. One of the monitored sensor signals in some such embodiments includes a shutter open sensor signal and the expected pattern of signals does not include the shutter open sensor signal indicating that a shutter is open either when a card is not detected in any part of the card reader or when a card is located within the card reader at a point at which the shutter should be closed.

One card reader device embodiment includes a card entrance for receiving a card and a card enclosure in registration with the card entrance and defining an area in which the card is read and including a plurality of position sensors for detecting a position of the card within the card enclosure. The card reader of this embodiment further includes a shutter located between the card entrance and the card enclosure, and including a shutter sensor indicating whether the shutter is open or closed and a transport mechanism for transporting a card between the card entrance and the card enclosure. The card reader further includes a controller including a processor and a memory that is operable to control the card reader device through performance of a plurality of data processing activities. The data processing activities may include controlling the transport mechanism and monitoring signals from the shutter sensor and the plurality of position sensors. The data processing activities of the controller may then compare the monitored sensor signals with an expected pattern of signals and declare an alert when the monitored sensor signals do not match the expected pattern of signals.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A method comprising:
monitoring signals from a plurality of sensors located within a card reader;
comparing the monitored sensor signals and times of receipt of the monitored signals with an expected pattern of signals stored in a memory including expected signals and expected times of receipt, the expected pattern of signals stored in a data structure in the memory, the stored pattern of signals instructing a controller of the card reader of a pattern for transporting the card within the card reader through manipulation of a card transport mechanism; and
declaring an alert when the monitored sensor signals do not match the expected pattern of signals.

2. The method according to claim 1, wherein the monitored sensor signals do not match the expected pattern of signals when the monitored signals include both a shutter open sensor signal indicating that a shutter is open and a card not present signal indicating that a card is not present in the card reader.

3. The method according to claim 1, wherein the monitored sensor signals do not match the expected pattern of signals when the monitored signals include both a shutter open sensor signal indicating that a shutter is open and a card present signal indicating that a card is present in the card reader at a point at which the shutter should be closed.

4. The method according to claim 1, wherein the method further comprises transporting a card within a card reader according to a card travel pattern.

5. The method according to claim 4, wherein comparing the monitored sensor signals includes comparing the monitored card position sensor signals with an expected pattern of signals corresponding to the card travel pattern.

6. The method according to claim 5, wherein the expected pattern of signals corresponding to the card travel pattern comprises a sequence of signals from a plurality of card position sensors located within the card reader device and beyond a shutter.

7. The method according to claim 4, wherein transporting a card within a card reader according to a card travel pattern includes reversing a direction of travel of the card within the card reader.

8. The method according to claim 4, wherein transporting a card within a card reader according to a card travel pattern includes selecting one of a plurality of different card travel patterns, each having a unique expected pattern of signals corresponding to that card travel pattern.

9. The method according to claim 4, wherein transporting a card within a card reader according to a card travel pattern includes stopping the card within the card reader for a first time period.

10. A method of operating a card reader device, the method comprising:
transporting a card within a card reader according to a card travel pattern stored in a memory including card positions and corresponding times;
monitoring signals from a plurality of sensors located within the card reader;
comparing monitored sensor signals and times of receipt of the monitored signals with an expected pattern of signals corresponding to the card travel pattern, the expected pattern of signals stored in a data structure in the memory, the stored pattern of signals instructing a controller of the card reader of a pattern for transporting the card within the card reader through manipulation of a card transport mechanism; and
declaring an alert when the monitored sensor signals do not match the expected pattern of signals corresponding to the card travel pattern.

11. The method of claim 10, wherein one of the monitored sensor signals comprises a shutter open sensor signal and the expected pattern of signals does not include the shutter open sensor signal indicating that a shutter is open either when a card is not detected in any part of the card reader or when a card is located within the card reader at a point at which the shutter should be closed.

12. The method of claim 11, wherein the expected pattern of signals corresponding to the card travel pattern comprises a sequence of signals from a plurality of card position sensors located within the card reader device and beyond a shutter.

13. The method of claim 10, wherein:
the travel pattern is defined in a card travel pattern data structure according to which the transporting of the card is performed and to which the monitored sensor signals are compared.

14. The method of claim 13, wherein the card travel pattern data structure is one of a plurality of card travel pattern data structures stored within a memory of the card reader device, the card travel pattern data structure selected from the plurality of card travel pattern data structures.

15. The method of claim 14, wherein the card travel pattern data structure selected from the plurality of card travel pattern data structures is selected according to a randomization algorithm.

16. A card reader device comprising:
a card entrance for receiving a card;
a card enclosure in registration with the card entrance and defining an area in which the card is read and including a plurality of position sensors for detecting a position of the card within the card enclosure;
a shutter located between the card entrance and the card enclosure, and
including a shutter sensor indicating whether the shutter is open or closed;
a transport mechanism for transporting a card between the card entrance and the card enclosure; and
a controller including a processor and a memory that is operable to control the card reader device through performance of a plurality of data processing activities comprising:
controlling the transport mechanism;
monitoring signals from the shutter sensor and the plurality of position sensors;
comparing the monitored sensor signals and times of receipt of the monitored signals with an expected pattern of signals stored in the memory including expected signals and expected times of receipt, the expected pattern of signals stored in a data structure in the memory, the stored pattern of signals instructing a controller of the card reader device of a pattern for transporting the card within the card reader device through manipulation of the transport mechanism; and
declaring an alert when the monitored sensor signals do not match the expected pattern of signals.

17. The card reader device of claim 16, wherein the controller declares an alert when the monitored shutter sensor signal indicates that the shutter is open when the controller is not activating the transport mechanism.

18. The card reader of claim 16, wherein the controller declares an alert when the expected pattern of signals comprises a sequence of signals from a plurality of position sensors that do not match the expected pattern of signals for a card being transported through the card enclosure.

19. The card reader of claim 18, wherein the sequence of signals includes a position sensor not detecting a card when a card would be expected to be present at that position sensor.

20. The card reader of claim 16, wherein the controller controls the transport mechanism according to a card travel pattern data structure that defines the expected pattern of signals of the comparing performed by the controller.
